(19) United States
(12) Patent Application Publication
(10) Pub. No.: US 2020/0015510 A1
(43) Pub. Date: Jan. 16, 2020

(54) APPARATUS AND METHODS FOR VAPORIZING AN HERB

(71) Applicant: ZHENGNAN DONG, Richmond Hill (CA)

(72) Inventor: ZHENGNAN DONG, Richmond Hill (CA)

(21) Appl. No.: 16/034,709

(22) Filed: Jul. 13, 2018

(51) Int. Cl. A24B 7/04; B02C 7/04; B02C 7/17; A24F 47/00; A24F 7/04

(52) U.S. Cl. CPC A24B 7/04; B02C 7/04; A24F 7/04; A24F 47/008; B02C 7/17

(57) ABSTRACT

Disclosed is an assembly for use in an herb vaporizer. The assembly includes a casing having at least one casing air passageway. The assembly also includes a first grinding element partially defining a grinding chamber and a second grinding element, opposed to said first grinding element, further defining the grinding chamber and rotatably mounted such that contents of the grinding chamber are agitated by rotation of the second grinding element. The assembly also includes a heater within the casing operatively associated with the grinding chamber, and being electrically coupled to a threaded connector providing an electric connection from a battery unit. The threaded connector projects from the casing for mating with an external battery unit.

### FIELD

This disclosure relates generally to apparatus and methods for vaporizing an herb.

### BACKGROUND

Electronic vaporization devices (also known as electronic-cigarettes or vaping devices) utilize electric power to heat liquids or herbs to create a vapor which users may inhale. In the industry, vaporizing is sometimes referred to as atomizing A limited number of vaporization devices are able to be used with herbs and, therefore, new vaporization apparatus and methods for use with herbs are desirable.

### SUMMARY

In accordance with an aspect of the present disclosure, there is provided an assembly for use in an herb vaporizer comprising a casing having at least one casing air passageway; a first grinding element partially defining a grinding chamber; a second grinding element, opposed to the first grinding element, further defining the grinding chamber and rotatably mounted such that contents of the grinding chamber are agitated by rotation of the second grinding element; a threaded connector projecting from the casing for mating with an external battery unit so as to provide an electrical connection from the battery unit to the threaded connector; and a heater within the casing operatively associated with the grinding chamber, the heater being electrically coupled to the threaded connector.

In one embodiment, the second grinding element has an annular wall with at least one air passageway, and the annular wall is aligned with the at least one casing air passageway such that rotation of the second grinding element rotates the at least one air passageway of the second grinding element into and out of alignment with the at least one casing air passageway, whereby selective rotation of the second grinding element controls airflow through the at least one casing air passageway and rotation of the second grinding element agitates the contents of the grinding chamber.

In one embodiment, the first grinding element has a first annular wall and the second grinding element has a second annular wall, and wherein the second annular wall at least partially overlaps with the first annular wall to define the grinding chamber between the first and second grinding elements.

In one embodiment, the heater abuts a face of the first grinding element external to the grinding chamber.

In one embodiment, the assembly also comprises an insulator within the casing and having an insulator wall defining at least one insulator air passageway, and wherein the at least one insulator air passageway and the at least one casing air passageway are in fluid communication.

In one embodiment, the insulator has an insulator floor, and the heater comprises a heating element sandwiched between the insulator floor and the face of the first grinding element.

In one embodiment, the assembly comprises a grinding element magnet fixed to the second grinding element for releasably securing the second grinding element to the insulator.

In one embodiment, the assembly comprises an insulator magnet fixed to the insulator for coupling with the grinding element magnet to releasably secure the second grinding element to the insulator.

In one embodiment, one of the first annular wall of the first grinding element and the insulator wall has a keyway and another of the first annular wall of the first grinding element and the insulator wall has a corresponding key, and wherein the key is received in the keyway to mount the first grinding element to the insulator.

In one embodiment, the heating element has positive and negative terminals, and wherein the positive and negative terminals extend through the insulator floor and couple to the threaded connector.

In one embodiment, the second grinding element has a disc-shaped wall defining an end of the grinding chamber, the disc-shaped wall having an axially directed opening, and wherein the assembly further comprises a mouthpiece in fluid communication with the axially directed opening.

In one embodiment, the assembly comprises a filter interposed between the disc-shaped wall and the mouthpiece for filtering air flowing from the grinding chamber to the mouthpiece.

In another aspect of the disclosure, there is provided an herb vaporizer comprising a control unit coupled to a battery unit; a casing having at least one casing air passageway; a first grinding element partially defining a grinding chamber; a second grinding element, opposed to the first grinding element, further defining the grinding chamber and rotatably mounted such that contents of the grinding chamber are agitated by rotation of the second grinding element; a heater within the casing operatively associated with the grinding chamber, the heater being electrically coupled to the control unit to provide an electrical connection from the battery unit to the heater; and wherein the second grinding element has an annular wall with at least one air passageway, the annular wall aligned with the at least one casing air passageway such that rotation of the second grinding element rotates the at least one air passageway of the second grinding element into and out of alignment with the at least one casing air passageway, whereby selective rotation of the second grinding element controls airflow through the at least one casing air passageway and rotation of the second grinding element agitates the contents of the grinding chamber.

In yet another aspect of the disclosure, there is provided a method for using an herb vaporizer having a casing with at least one casing air passageway, the method comprising: providing an herb to a grinding chamber of the herb vaporizer, the grinding chamber defined by a first grinding element and a second grinding element, the second grinding element opposed to the first grinding element and rotatably mounted such that the herb is agitated by rotation of the second grinding element, and wherein the second grinding element has an air passageway which, by rotating the second grinding element, is selectively positioned in fluid communication with the at least one casing air passageway; applying heat to the grinding chamber using a heater operatively associated with the grinding chamber; and rotating the second grinding element to control an air flow to the grinding chamber and to further agitate the herb.

In one embodiment, the second grinding element has an annular wall with the air passageway such that rotating the second grinding element rotates the air passageway of the circumferential wall into and out of alignment with the at least one casing air passageway, thereby selectively controlling airflow through the at least one casing air passageway.

Other aspects, features, and embodiments of the present disclosure will become apparent to those of ordinary skill in the art upon review of the following description of specific embodiments in conjunction with the accompanying figures.

### BRIEF DESCRIPTION OF DRAWINGS

In the figures, which illustrate, by way of example only, embodiments of the present disclosure:

FIG. 1 is a bottom-up perspective view of an example embodiment of an herb holding assembly for use in a vaporizer;

FIG. 2 is a top-down exploded view of an upper member of the assembly of FIG. 1;

FIG. 3 is a bottom-up exploded view of the upper member of FIG. 2;

FIG. 4A is a top-down perspective view of the upper member of FIG. 2;

FIG. 4B is a bottom-up perspective view of the upper member of FIG. 2;

FIG. 4C is a side view of the upper member of FIG. 2;

FIG. 4D is a top view of the upper member of FIG. 2;

FIG. 4E is a bottom view of the upper member of FIG. 2;

FIG. 4F is a cross-section view of the upper member of FIG. 2 along the lines IV-IV of FIG. 4E;

FIG. 5 is a top-down exploded view of a base of the assembly of FIG. 1;

FIG. 6 is a bottom-up exploded view of the base of FIG. 5;

FIG. 7A is a top-down perspective view of the base of FIG. 5;

FIG. 7B is a bottom-up perspective view of the base of FIG. 5;

FIG. 7C is a side view of the base of FIG. 5;

FIG. 7D is a top view of the base of FIG. 5;

FIG. 7E is a bottom view of the base of FIG. 5;

FIG. 7F is a cross-section view of the base of FIG. 5 along the lines VII-VII of FIG. 7E;

FIG. 8 is a top-down perspective view of the assembly of FIG. 1, in an open configuration;

FIG. 9 is a bottom-up perspective view of the assembly of FIG. 1, in the open configuration;

FIG. 10 is a cross-section view of the assembly of FIG. 1; and

FIGS. 11A-11C are perspective views of the assembly of FIG. 1 in different operational positions.

### DETAILED DESCRIPTION

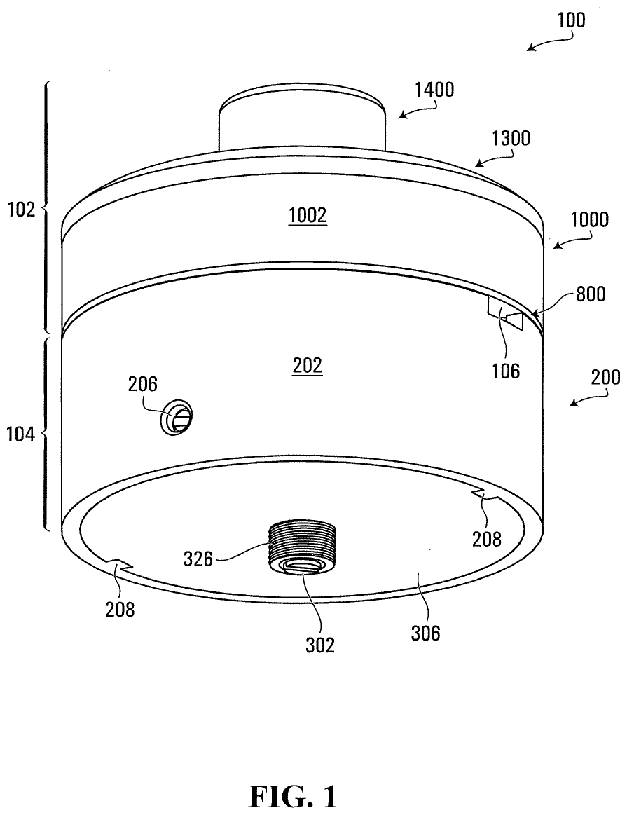

Referencing FIG. 1, assembly 100 has an upper member 102 magnetically joined to a base 104.

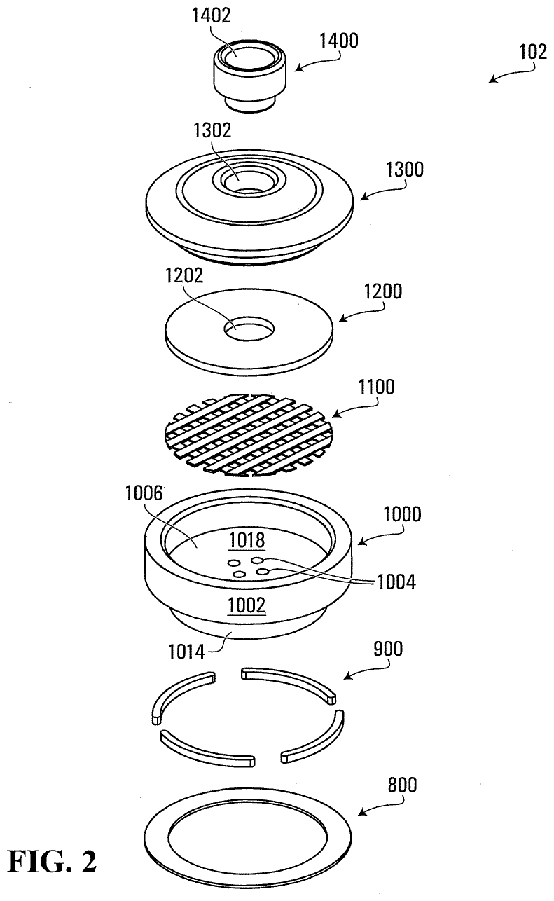

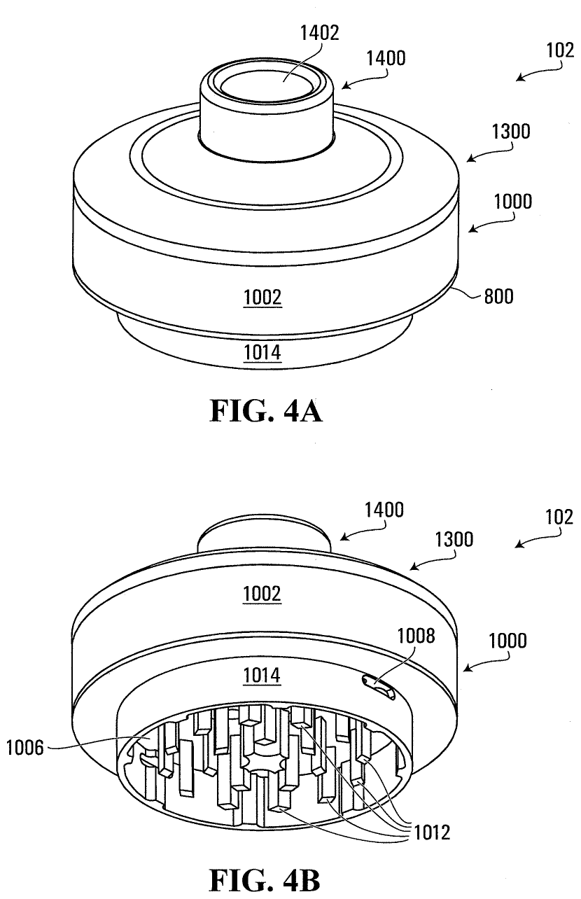

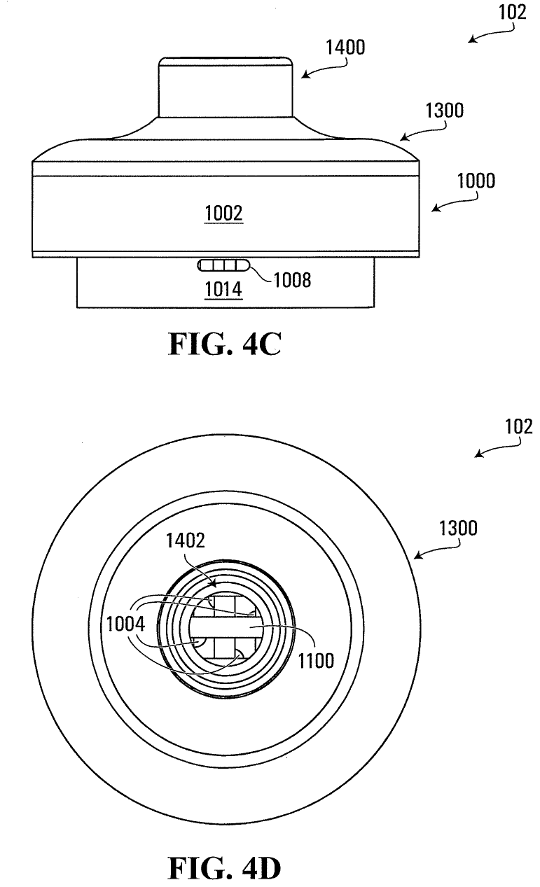

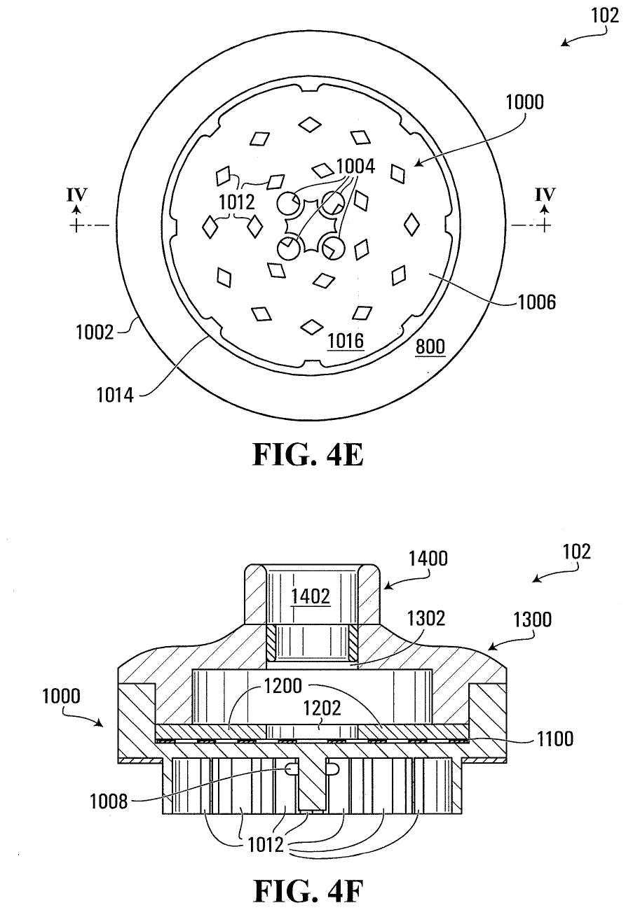

Turning to FIGS. 2 to 4, upper member 102 has a mouthpiece 1400 press fit to a top cap 1300. The top cap 1300 is press fit or screwed to a top grinding element 1000 and sandwiches a thermal insulator 1200 and filter 1100 between the top cap and a top face 1018 of a disc-shaped wall 1006 of the top grinding element 1000.

Filter 1100 may be a mesh filter, a foam filter, a carbon filter, a charcoal filter, a film filter, or a self-contained water filter amongst others.

Mouthpiece 1400, top cap 1300, and insulator 1200 have openings 1402, 1302, and 1202 respectively, to allow air to flow from top grinding element 1000, through filter 1100 to mouthpiece 1400.

Disc-shaped wall 1006 also has axially directed openings 1004 to allow air from below wall 1006 to flow from top grinding element 1000 to mouthpiece opening 1402.

Teeth 1012 project downwardly from the bottom face 1016 of the disc-shaped wall 1006 of top grinding element 1000.

The disc-shaped wall 1006 of top grinding element 1000 forms a floor for an upper annular wall 1002 of the top grinding element. A smaller diameter lower annular wall 1014 depends from the disc-shaped wall.

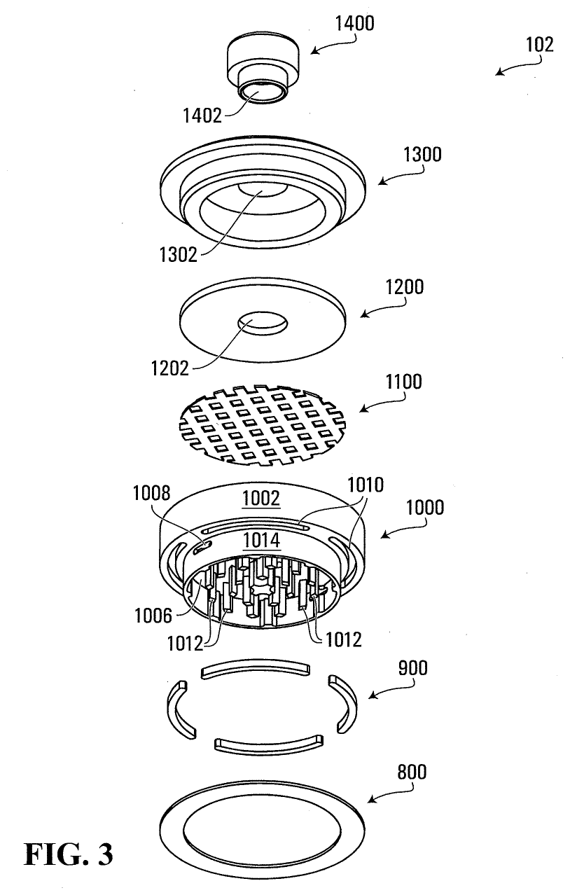

Arcuate grooves 1010 (FIG. 3) extend into the bottom surface of the disc-shaped wall 1006 between the upper and lower annular walls 1002, 1014. These grooves receive arcuate magnets 900 which, as will become apparent, function to releasably secure upper member 102 to base 104. An O-ring 800 is received on lower annular wall 1014 and covers magnets 900.

Lower annular wall 1014 has one or more radial passageways 1008 (FIG. 3) therein to allow air to flow into top grinding element 1000.

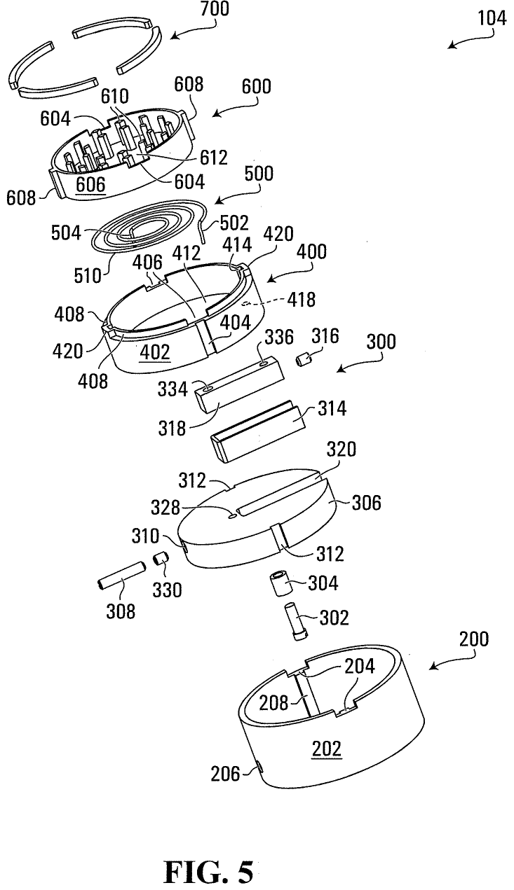

Turning to FIGS. 5-7, base 104 has a casing in the nature of a cylindrical sleeve 200 with upper notches 204 that act as sleeve air passageways, a radially directed bore 206, and a pair of opposed axially extending keys 208 extending from the base of notches 204.

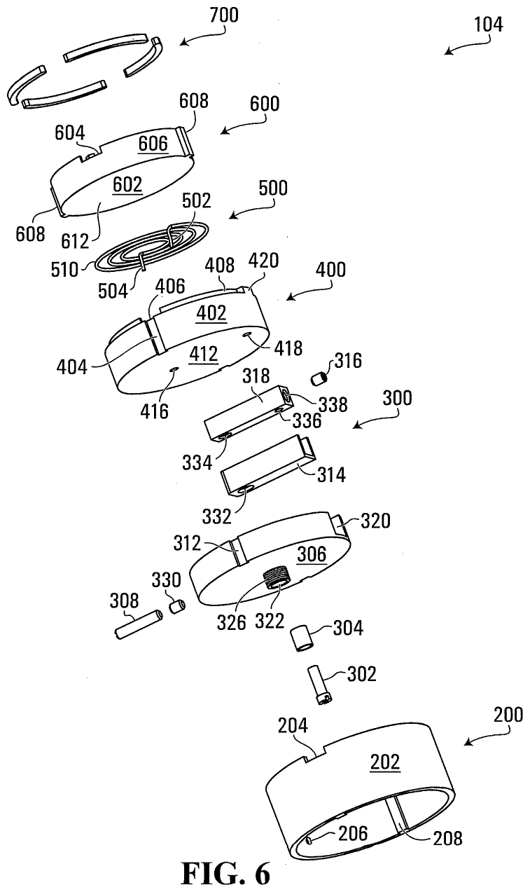

A disc-shaped negative terminal block 306 has an opening 322 (FIG. 6) extending along its central axis. Opening 322 is partially defined by a downwardly directed and externally threaded central annular projection 326. Block 306 also has a radially directed notch 320 that extends past the central axis of the block and also opens to the top of the block. An axial opening 328 (FIG. 5) extends into the top of the block and a radially directed bore 310 (FIG. 5) extends from a side of the block to axial opening 328. Block 306 also has a pair of opposed axially extending keyways 312. The negative terminal block sits within sleeve 200 with keyways 312 receiving keys 208 of the sleeve 200 thereby locking the block 306 against rotation.

A pin 330 is inserted into radial bore 310 of the negative terminal block 306 and pushed into position by a set screw 308. As will become apparent hereinafter, this allows the pin 330 to hold a negative terminal of a heater against an inner wall of the negative terminal block 306. Set screw 308 is positioned to lie within sleeve bore 206 and negative terminal block bore 310 in order to hold the negative terminal block within the sleeve.

As best shown in FIG. 6, a rectangular insulative sleeve 314 is received by groove 320 of the negative terminal block 306 and the insulative sleeve 314 receives, in turn, rectangular positive terminal block 318. The inner end of the insulative sleeve has an axially directed opening 332 aligned with the central opening 322 of the negative terminal block. The positive terminal block 318 has a smaller diameter axially directed opening 334 also aligned with the central opening 322 of the negative terminal block 306. An insulative ring 304 projects through central opening 322 of block 306 and opening 332 of insulative sleeve 314 to abut the bottom of positive terminal block 318. A conductive, positive terminal pin 302 projects through openings 322, 332, and 334 to connect to the positive terminal block 318.

The outer end of the positive terminal block 318 has an axially directed unthreaded opening 336 extending from its top to bottom surfaces and a radially directed threaded opening 338 extending from its outer end to the unthreaded opening 336. A conductive set screw 316 is threaded into threaded opening 338 in order to hold a positive terminal of the heater to the positive terminal block 318, as will become apparent hereinafter.

Positive terminal pin 302 and negative terminal annular projection 326 protrude from an end of sleeve 200 and act as a connector to allow heater 500 to couple to with a source of electric power. In particular, annular projection 326 may have external threading that accords with any one of a variety of standard connectors used in the vaporizer industry, such as the 510 connector, amongst others. To accord to with the industry standard 510 connector, annular projection 326 may have an external diameter of 7 mm, may project outwardly by 3 to 5 mm from negative terminal block 306, and may have one to 10 threads with a thread pitch of 0.5 mm.

An insulator 400 has an annular wall 402 and a floor 412. The annular wall 402 has upper notches 406 that act as air passageways, a pair of opposed outwardly directed keyways 404, a pair of opposed inwardly directed keyways 414 and upper arcuate ledges 408. The floor 412 has axial openings 416 and 418 (FIG. 6). The insulator 400 sits inside sleeve 200 in abutment with the negative terminal block 306 with its outwardly directed keyways 404 received by keys 208 of the sleeve 200 thereby locking the insulator 400 against rotation within the sleeve. In this position, the upper notches 406 of the insulator are aligned with the upper notches 204 of the sleeve 200.

A resistive coil 510 of a heater 500 sits on the floor 412 of insulator 400. A finger 502 at an outer end of the coil 510 projects through opening 418 in floor 412 and is received by opening 336 in the positive terminal block 318 and held to this block by set screw 316. This finger acts as the positive terminal for the heater 500. A second finger 504 at an inner end of the coil 510 extends through opening 416 of floor 412 and is received by opening 328 (FIG. 5) of the negative terminal block 306 and held to the negative terminal block by conductive pin 330 that is pushed against finger 504 by set screw 308. This finger acts as the negative terminal for the heater 500.

The upper arcuate ledges 408 of the insulator 400 receive arcuate magnets 700 that, with the insulator sitting inside sleeve 200 are sandwiched between ledges 408 of the insulator 400 and sleeve 200. The magnets are held against sliding by abutments 420 of the insulator 400.

A bottom grinding element 600 has an annular wall 606 and a floor 612. The annular wall 606 has upper notches 604 that act as air passageways and a pair of opposed keys 608. The floor 612 supports upwardly directed teeth 610. The bottom grinding element 600 sits within insulator 400 with its keys 608 received by inwardly directed keyways 414 of the insulator 400. This locks the bottom grinding element 600 against rotation within the insulator 400 with the upper notches 604 of the bottom grinding element 600 aligned with upper notches 406 of the insulator 400 and notches 204 of the sleeve 200.

With the bottom grinding element 600 sitting within the insulator 400, heater 500 is sandwiched between the floor 612 of the bottom grinding element 600 and the floor 412 of insulator 400.

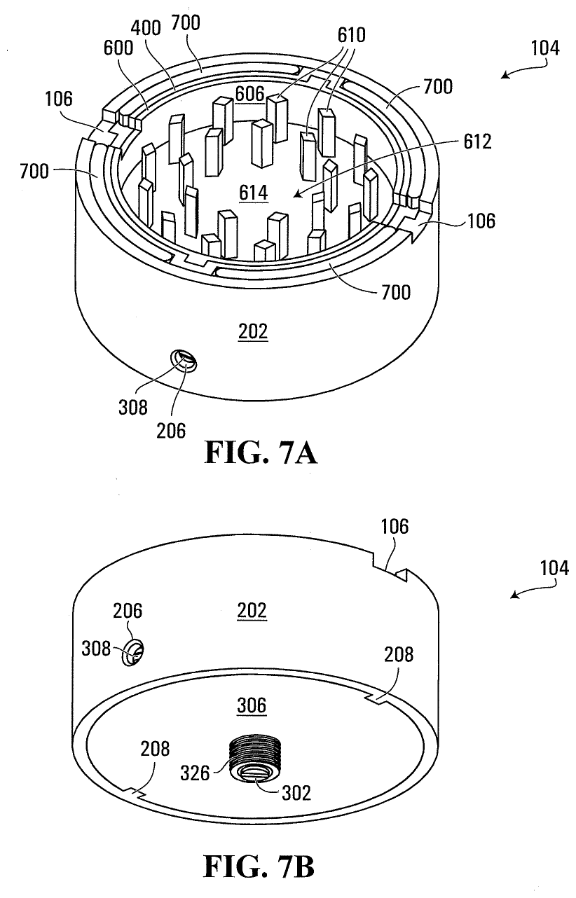

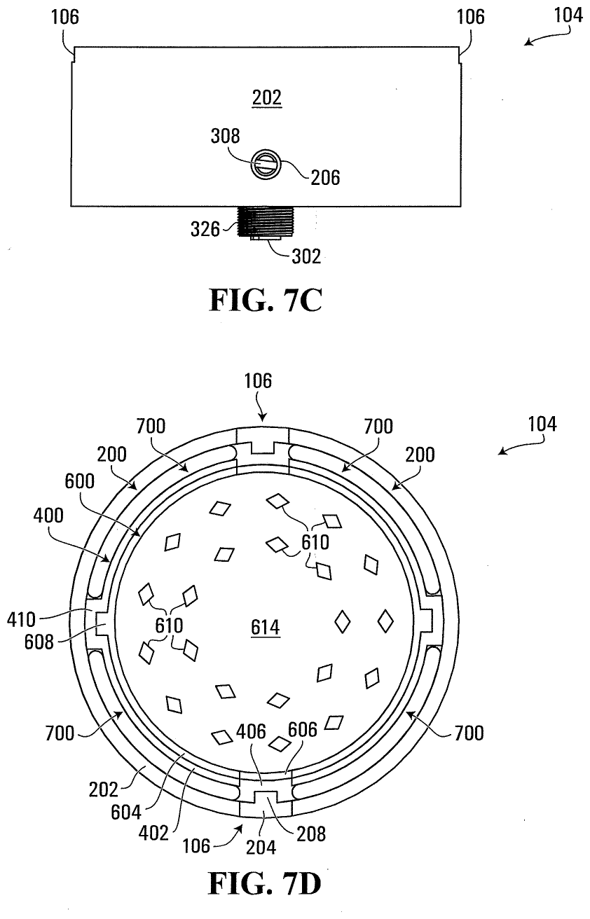

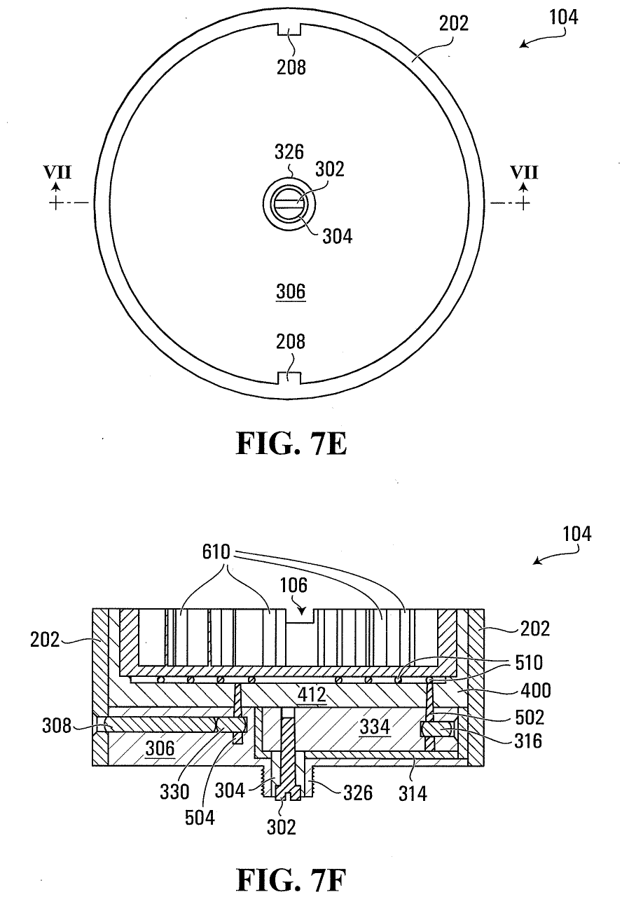

It will be apparent that once bottom grinding element 600 and insulator 400 are secured within sleeve 200 the bottom grinding element air notches 604, insulator air notches 406, and sleeve notches 204 (collectively, base notches 106) are aligned and in fluid communication with one another (FIG. 7).

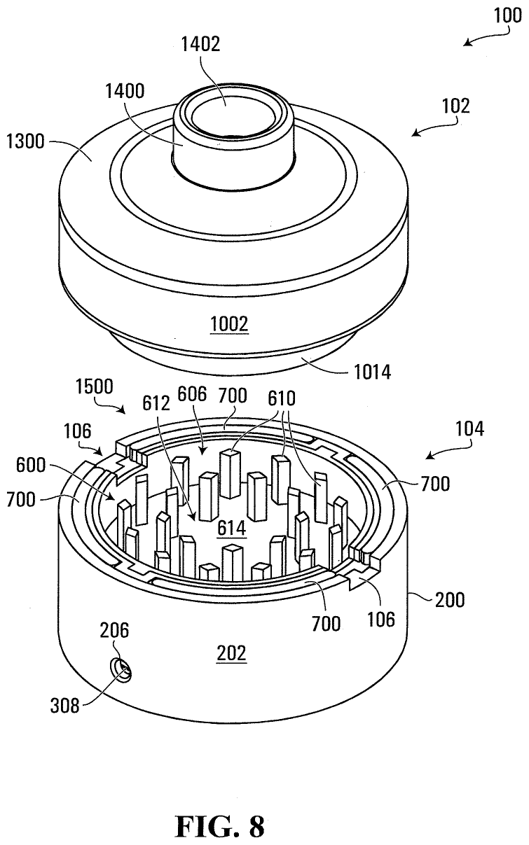

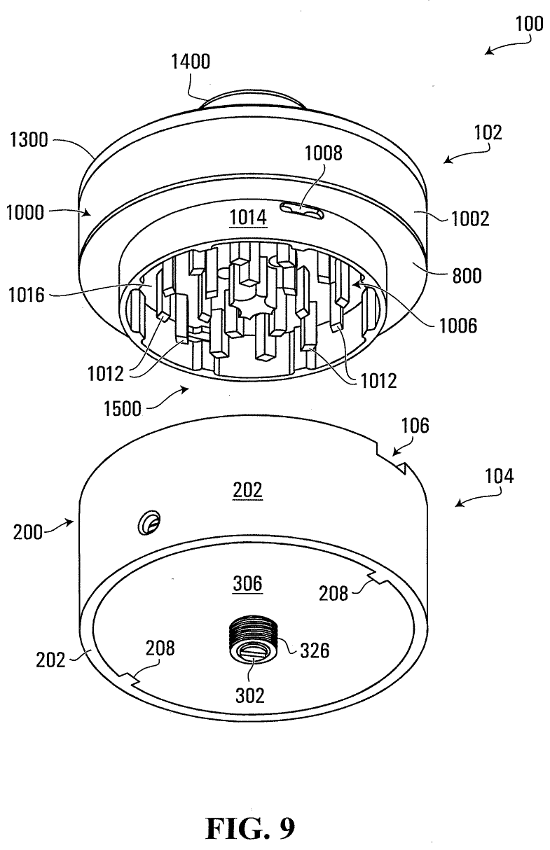

FIGS. 8-9 show the assembled upper member 102 and assembled base 104 separated from each other. From this it will be apparent teeth 1012 of upper member 102 and teeth 610 of base 104 project toward one another. When upper member 102 and base 104 are brought together, a bottom face 1016 of disc-shaped wall 1006 of top grinding element 1000 opposes a top face 614 of floor 612 of bottom grinding element 600 and bottom annular wall 1014 of the top grinding element 1000 partially overlaps with annular wall 606 of the bottom grinding element 600. Top grinding element 1000, along with bottom grinding element 600, thereby define a grinding chamber 1500. When upper member 102 and base 104 are brought together, O-ring 800 creates a seal between the upper member and base.

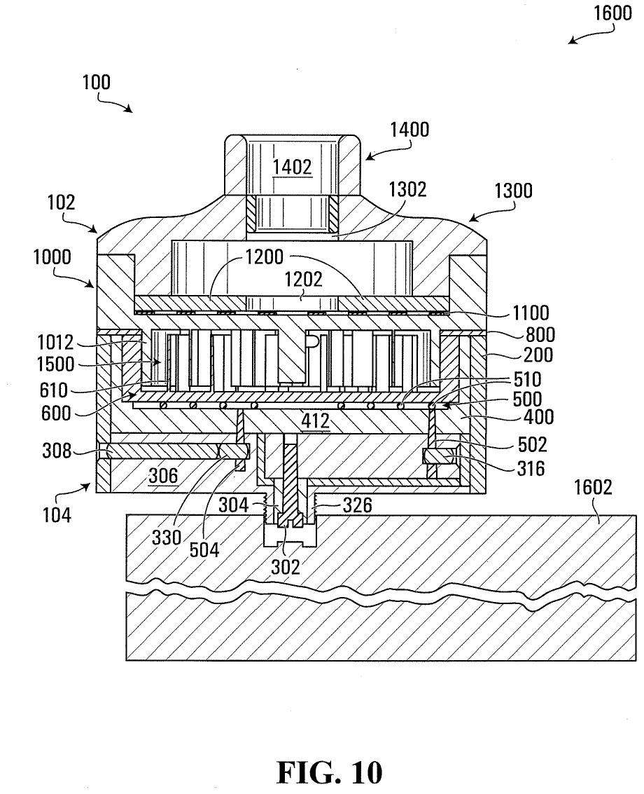

Turning to FIG. 10, assembly 100 can be attached to a control unit 1602 to form a vaporizer 1600. More specifically, control unit 1602 has a threaded connector (such as a 510 connector) suitable for receiving the externally threaded annular projection 326 of base 104. Coupling base 104 and control unit 1602 causes annular projection 326 and protruding pin 302 to couple with negative and positive terminals, respectively, of a battery unit (not shown) within control unit 1602. Annular projection 326 and pin 302 thereby provide an electric connection between the battery unit of control unit 1602 and heater 500.

With the assembly 100 connected to the control unit, electricity may be selectively supplied through pin 302 and annular projection 326 to heater 500.

Control unit 1602 may include a controller (e.g. a microprocessor or a control circuit, not shown) to control the power output to heater 500, and thereby control the heat generated by heater 500. Control unit 1602 may also include one or more input devices to receive a user input indicative of a power output and may set the power output based on the user input.

In use, prior to bringing the top member 102 and base 104 together, the bottom grinding element 600 may be filled with one or more herbs or other plant material. When brought together, grinding chamber 1500 is formed and the attraction of magnets 900 of the upper member 102 to magnets 700 of the base 104 releasably hold the upper member 102 and base 104 together.

Heat may then be applied to grinding chamber 1500 by controlling control unit 1602 to provide electric power to heater 500. Heater 500 is operatively associated with grinding chamber 1500 and heats the contents of grinding chamber 1500 indirectly. More specifically, heater 500 abuts bottom face 602 of floor 612, which is external to grinding chamber 1500. The contents of grinding chamber sit atop floor 612 and do not contact this bottom face 602. Thus, the contents of grinding chamber 1500 are prevented from directly contacting heater 500. Avoiding direct contact with heater 500 reduces the risk of the contents of the grinding chamber 1500 burning. Floor 612, instead, spreads the heat from heater 500 evenly across its surface and to annular wall 606 and teeth 610, thereby reducing this risk.

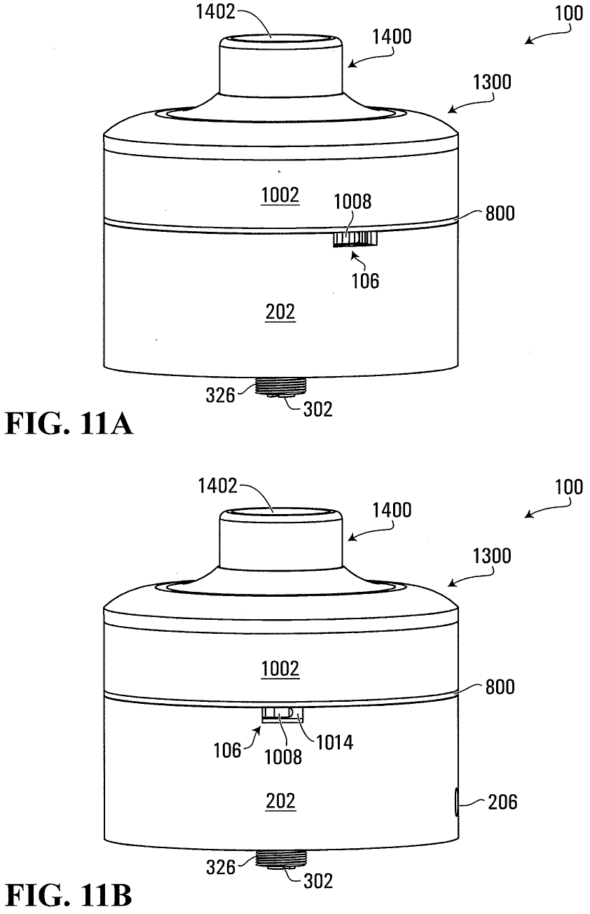

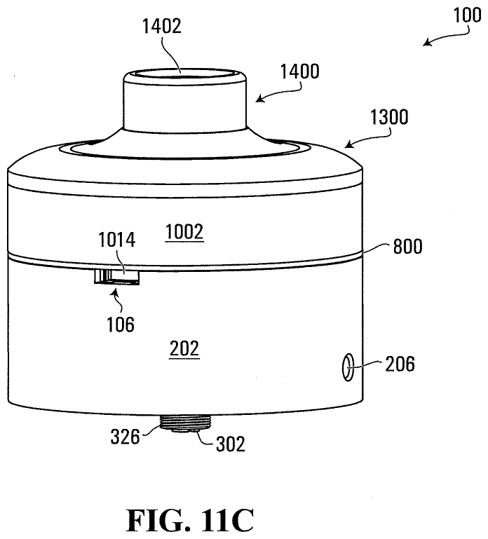

Heating grinding chamber 1500 cause constituents of herbs held in the chamber to vaporize. The temperature of grinding chamber 1500 may be controlled by control unit 1602. The temperature of grinding chamber 1500 may also be controlled by adjusting the alignment of base vents 106 and radial passageways 1008. In particular, base vents 106 and passageways 1008 may be brought into alignment by selectively rotating top grinding element 1000 relative to bottom grinding element 600, thereby opening an airway to grinding chamber 1500. The base vents 106 and passageways 1008 may be fully aligned (FIG. 11A), partially aligned (FIG. 11B), or fully out of alignment (FIG. 11C). When the base vents 106 and passageways 1008 are fully or partially aligned, air will flow into chamber 1500 and out of the mouthpiece opening 1402, thereby reducing the temperature within the chamber.

The herb or other material within grinding chamber 1500 may be heated unevenly, with portions of the herb abutting top face 614 of floor 612 heated more quickly and at a higher temperature than portions of the herb further away from top face 614. To avoid this, the contents of grinding chamber 1500 may be agitated and ground by rotating upper member 102 of assembly 100 relative to the base 104 which will bring new portions of the herb into contact with top face 614 of floor 612 and with teeth 610, thereby providing more even heating.

With the airway to the grinding chamber 1500 open and the herb, or other material, at a desired temperature, a user may inhale through mouthpiece 1400, thereby causing air to flow through the base airway 106 and radial passageways 1008 of the top grinding element 1000 into the top grinding element, then through the axial openings 1004 of top grinding element 1000, through air filter 1100 and through mouthpiece opening 1402.

It will be apparent from the foregoing that top grinding element 1000 may be selectively rotated relative to bottom grinding element 600 to open an airway to grinding chamber 1500 and may also be rotated to agitate the herb, or other material, within grinding chamber 1500. Thus, rotation of the top grinding element relative to the bottom grinding element serves two purposes. This double use reduces the number of parts needed and therefore reduces manufacturing cost. This dual use also reduces the complexity of the user interface, and may be more convenient to the user.

While heater 500 has been described as a coil resistive heater, any other suitable heater such as a conduction, convention, radiation, or ultrasonic heater could be used. Further, while heater 500 is shown as spiral shaped, it may square-shaped, rectangle-shaped, or circle-shaped, and may be formed of a mesh or a series of links.

Further, floor 612 of the bottom grinding element 600 may have grooves (not shown) in which the heater 500 may be embedded. Similarly, floor 412 of the insulator 400 may also have grooves (not shown) in which the heater may also be embedded. By embedding the heater 500 in grooves of the floor 612 and in grooves of the floor 412, the airspace between the bottom grinding element 600 and the top of the insulator 400 is minimized. This improves efficiency of the heater as it minimizes the wasted heating of air in this airspace. Furthermore, with the heater 500 embedded in grooves of the floor 612, the heater 500 is in contact with a larger surface area of the bottom grinding element 600, which may increase the efficiency of heater 500 in heating the chamber 1500. With the heater 500 is embedded in grooves of the floor 412, the heater 500 is in contact with a larger surface area of the insulator 400, which may increase the efficiency of the insulator 400 at insulating the heat output of the heater 500. In addition, by embedding the heater 500 in grooves of either the floor 612 or the insulator 400, base 104 may occupy a smaller volume.

In an alternative embodiment, vaporizer 1600 may have a base assembly that is permanently mounted to a control unit.

In the illustrated embodiment, the insulator is positioned above the filter but in an alternate embodiment, insulator 1200 is positioned below filter 1100.

In an alternative embodiment, notches that form base notches 106 (i.e. bottom grinding element notches 604, insulator notches 406, and notches 204) may be provided in the form of through holes instead of notches. Further, although the figures show two of each notches 604, 406, 204, a different number of notches may be provided.

In an alternative embodiment, axially directed openings 1004 of top grinding member 1000 may be selectively opened and closed by rotating any one of filter 1100, insulator 1200, or top cap 1300.

In one embodiment, radial bore 310 of negative terminal block 306 may be threaded and configured to receive a threaded pin 330 and set screw 308. In another embodiment, radial bore 310 may be unthreaded. An unthreaded pin 330 and set screw 308 may be press-fit into the unthreaded radial bore 310. Both pin 330 and set screw 308 may be made of either a conductive or non-conductive material.

In one embodiment, chamber 1500 is heated to a temperature in the range of 100 to 240° C.

In one embodiment, casing 200 and top grinding element 1000 may have visual indicator that the base vents 106 and radial passageways 1008 are in alignment. The visual indicator could be, for example, a marking or an indentation.

While the described casing 200 for the base 104 is in the nature of a sleeve, other types of casings may be used, such as a casing that envelopes the sides and bottom of the base 104 other than annular projection 326 and pin connector 302.

Teeth 1012 of top grinding element 1000 and teeth 610 of bottom grinding element 600 may have any number of shapes and sizes, such as square-shaped, s-shaped, x-shaped, diamond-shaped, star-shaped. In addition, each tooth of each grinding element 1000, 600 may be shaped differently from other teeth of that grinding element 1000, 600 to facilitate improved grinding and agitation of the herbs in chamber 1500.

As will be appreciated, a wide variety of materials may be used to construct various elements of assembly 100. For example, the top and bottom grinding elements 1000, 600 may be made using materials suitable for grinding an herb, such metallic materials (e.g. stainless steel or aluminum), ceramics, or glass. Insulators 1200, 400 may be made using thermally insulating materials that can withstand the high temperatures needed for vaporizing herbs, such as polymers, plastics, wood, glass, or composites. Casing 200 may be made of any number of materials, such as metals, woods, composites, ceramics, glass, polymers, or plastics.

Of course, the above described embodiments of the present disclosure are intended to be illustrative only and in no way limiting. The described embodiments are susceptible to many modifications of form, arrangement of parts, details and order of operation. The invention, rather, is intended to encompass all such modification within its scope, as defined by the claims.

What is claimed is:

1. An assembly for use in an herb vaporizer comprising:
a casing having at least one casing air passageway;
a first grinding element partially defining a grinding chamber;
a second grinding element, opposed to said first grinding element, further defining said grinding chamber and rotatably mounted such that contents of said grinding chamber are agitated by rotation of said second grinding element;
a threaded connector projecting from said casing for mating with an external battery unit so as to provide an electrical connection from said battery unit to said threaded connector; and
a heater within said casing operatively associated with said grinding chamber, said heater being electrically coupled to said threaded connector.

2. The assembly of claim 1, wherein said second grinding element has an annular wall with at least one air passageway, said annular wall aligned with said at least one casing air passageway such that rotation of said second grinding element rotates said at least one air passageway of said second grinding element into and out of alignment with said at least one casing air passageway, whereby selective rotation of said second grinding element controls airflow through said at least one casing air passageway and rotation of said second grinding element agitates the contents of said grinding chamber.

3. The assembly of claim 1, wherein said first grinding element has a first annular wall and said second grinding element has a second annular wall, and wherein said second annular wall at least partially overlaps with said first annular wall to define said grinding chamber between said first and second grinding elements.

4. The assembly of claim 2, wherein said heater abuts a face of said first grinding element external to said grinding chamber.

5. The assembly of claim 4, further comprising an insulator within said casing and having an insulator wall defining at least one insulator air passageway, and wherein said at least one insulator air passageway and said at least one casing air passageway are in fluid communication.

6. The assembly of claim 5, wherein said insulator has an insulator floor, and wherein said heater comprises a heating element sandwiched between said insulator floor and said face of said first grinding element.

7. The assembly of claim 6, further comprising a grinding element magnet fixed to said second grinding element for releasably securing said second grinding element to said insulator.

8. The assembly of claim 7, further comprising an insulator magnet fixed to said insulator for coupling with said grinding element magnet to releasably secure said second grinding element to said insulator.

9. The assembly of claim 8, wherein one of said first annular wall of said first grinding element and said insulator wall has a keyway and another of said first annular wall of said first grinding element and said insulator wall has a corresponding key, and wherein said key is received in said keyway to mount said first grinding element to said insulator.

10. The assembly of claim 9, wherein said heating element has positive and negative terminals, and wherein said positive and negative terminals extend through said insulator floor and couple to said threaded connector.

11. The assembly of claim 10, wherein said second grinding element has a disc-shaped wall defining an end of the grinding chamber, said disc-shaped wall having an axially directed opening, and wherein the assembly further comprises a mouthpiece in fluid communication with said axially directed opening.

12. The assembly of claim 11, further comprising a filter interposed between said disc-shaped wall and said mouthpiece for filtering air flowing from said grinding chamber to said mouthpiece.

13. An herb vaporizer comprising:
a control unit coupled to a battery unit;
a casing having at least one casing air passageway;
a first grinding element partially defining a grinding chamber;
a second grinding element, opposed to said first grinding element, further defining said grinding chamber and rotatably mounted such that contents of said grinding chamber are agitated by rotation of said second grinding element;
a heater within said casing operatively associated with said grinding chamber, said heater being electrically coupled to said control unit to provide an electrical connection from said battery unit to said heater; and
wherein said second grinding element has an annular wall with at least one air passageway, said annular wall aligned with said at least one casing air passageway such that rotation of said second grinding element rotates said at least one air passageway of said second grinding element into and out of alignment with said at least one casing air passageway, whereby selective rotation of said second grinding element controls airflow through said at least one casing air passageway and rotation of said second grinding element agitates the contents of said grinding chamber.

14. The herb vaporizer of claim 13, wherein said first grinding element has a first annular wall and said second grinding element has a second annular wall, and wherein said second annular wall at least partially overlaps with said first annular wall to define said grinding chamber between said first and second grinding elements.

15. The herb vaporizer of claim 14, wherein said heater abuts a face of said first grinding element external to said grinding chamber.

16. A method for using an herb vaporizer having a casing with at least one casing air passageway, the method comprising:
providing an herb to a grinding chamber of said herb vaporizer, the grinding chamber defined by a first grinding element and a second grinding element, said second grinding element opposed to said first grinding element and rotatably mounted such that said herb is agitated by rotation of said second grinding element, and wherein the second grinding element has an air passageway which, by rotating said second grinding element, is selectively positioned in fluid communication with said at least one casing air passageway;
applying heat to said grinding chamber using a heater operatively associated with said grinding chamber; and
rotating said second grinding element to control an air flow to said grinding chamber and to further agitate said herb.

17. The method of claim 16, wherein said second grinding element has an annular wall with said air passageway such that rotating said second grinding element rotates said air passageway of said circumferential wall into and out of alignment with said at least one casing air passageway, thereby selectively controlling airflow through said at least one casing air passageway.
